(19) United States
(12) Patent Application Publication
(10) Pub. No.: US 2023/0058444 A1
(43) Pub. Date: Feb. 23, 2023

(54) METHODS AND SYSTEMS FOR FACILITATING MAINTAINING A RECORD OF A WORK ORDER

(71) Applicant: Roberta Kelley, North Bethesda, MD (US)

(72) Inventor: Roberta Kelley, North Bethesda, MD (US)

(21) Appl. No.: 17/891,717

(22) Filed: Aug. 19, 2022

Related U.S. Application Data
(60) Provisional application No. 63/235,056, filed on Aug. 19, 2021.

(51) Int. Cl. G06Q 10/06; G06Q 10/00

(52) U.S. Cl. CPC G06Q 10/063114; G06Q 10/20

(57) ABSTRACT

The present invention provides a method and a system for receiving a tenant data, analyzing the tenant data to generate a tenant account, receiving a work order from the at least one tenant device, transmitting the work order and the tenant data to at least one maintenance team, receiving a response corresponding to the work order from the maintenance team, transmitting the response to the tenant, receiving a work status corresponding to the work order from the maintenance team, processing the work order and the work status, generating a work insight based on the processing, transmitting the work insight to the tenant, receiving a review corresponding to the work done by the maintenance team from the tenant, transmitting the review to the maintenance team, and storing the review, the work insight, the tenant data, and the response.

### FIELD OF THE INVENTION

The present invention relates generally to data processing. More specifically, the present invention is methods and systems for facilitating maintaining a record of a work order.

### BACKGROUND OF THE INVENTION

The field of data processing is technologically important to several industries, business organizations, and/or individuals.

Generally, reporting a maintenance project and then tracking the progress of the maintenance project (or work issue) requires a lot of formal paperwork and special training. This process is time-consuming and takes a toll on the mental health of the tenant. Existing techniques for facilitating maintaining a record of a work order are deficient with regard to several aspects. For instance, current technologies consume a lot of time for a tenant to accurately describe a work issue that the tenant is experiencing. This is often tiring and a cumbersome process. Furthermore, current technologies do not allow the tenant to track the progress of the work issue (or order) using visual illustrations that are easy to comprehend.

Therefore, there is a need for improved methods and systems for facilitating maintaining a record of a work order that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a method for facilitating maintaining a record of a work order is disclosed. Accordingly, the method may include receiving, using a communication device, a tenant data from at least one tenant device associated with at least one tenant. Further, the method may include analyzing, using a processing device, the tenant data to generate a tenant account. Further, the method may include receiving, using a communication device, a work order from the at least one tenant device. Further, the method may include transmitting, using the communication device, the work order and the tenant data to at least one maintenance team device associated with the maintenance team. Further, the method may include receiving, using the communication device, a response corresponding to the work order from the at least one maintenance team device. Further, the method may include transmitting, using the communication device, the response to the at least one tenant device. Further, the method may include receiving, using the communication device, a work status corresponding to the work order from the at least one maintenance team device. Further, the method may include processing, using the processing device, the work order and the work status. Further, the method may include generating, using the processing device, a work insight based on the processing. Further, the method may include transmitting, using the communication device, the work insight to the at least one tenant device. Further, the method may include receiving, using the communication device, a review corresponding to the work done by the at least one maintenance team from the at least one tenant device. Further, the method may include transmitting, using the communication device, the review to the at least one maintenance team device. Further, the method may include storing, using a storage device, the review, the work insight, the tenant data, and the response.

According to some aspects, a system for facilitating maintaining a record of a work order is disclosed. Accordingly, the system may include a communication device configured for receiving a tenant data from at least one tenant device associated with at least one tenant. Further, the communication device may be configured for receiving a work order from the at least one tenant device. Further, the communication device may be configured for transmitting the work order and the tenant data to at least one maintenance team device associated with the maintenance team. Further, the communication device may be configured for receiving a response corresponding to the work order from the at least one maintenance team device. Further, the communication device may be configured for transmitting the response to the at least one tenant device. Further, the communication device may be configured for receiving a work status corresponding to the work order from the at least one maintenance team device. Further, the communication device may be configured for transmitting a work insight to the at least one tenant device. Further, the communication device may be configured for receiving a review corresponding to the work done by the at least one maintenance team from the at least one tenant device. Further, the communication device may be configured for transmitting the review to the at least one maintenance team device. Further, the system may include a processing device configured for analyzing the tenant data to generate a tenant account. Further, the processing device may be configured for processing the work order and the work status. Further, the processing device may be configured for generating the work insight based on the processing. Further, the system may include a storage device configured for storing the review, the work insight, the tenant data, and the response.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating maintaining a record of a work order, in accordance with some embodiments.

FIG. 3 is a flowchart of a method for facilitating maintaining a record of a work order, in accordance with some embodiments.

FIG. 4 is a flowchart of a method for facilitating maintaining a record of a work order, in accordance with some embodiments

FIG. 5 is a flowchart of a method for facilitating maintaining a record of a work order, in accordance with some embodiments.

FIG. 6 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating maintaining a record of a work order, embodiments of the present disclosure are not limited to use only in this context.

Overview:

The present disclosure describes methods and systems for facilitating maintaining a record of a work order. The disclosed system makes entering a work order into a computer system simple and efficient. Further, the disclosed system may be configured for providing an accurate description of the issue the tenant is experiencing to the maintenance team member by using the most common work orders, a detailed form that allows the tenant to take a picture with a phone or use a photo stored in phone database. Once the work order is received, the disclosed system may allow the tenant may track the work order by viewing a tracking screen that provides a test tube or thermometer shape that fills up every time the maintenance team member accomplishes a task regarding the tenant work order. Once the work order is completed, the tenant may be automatically transferred to the final screen that may include a review screen with 5 empty fill stars. Once the tenant selects the appropriate number of stars, the tenant believes the maintenance member deserves (5 being Extremely Satisfied and 1 being Not satisfied). Further, the tenant may be directed back to a home screen. If for any reason the maintenance team member needs to order a part or hire a contractor to complete the tenant work order, the work order screen may remain in tracking screen mode until the maintenance team member submits a new time of arrival. Further, the tenant may refresh their screen on the tracker screen if for any reason it has not been immediately updated.

Further, the property management company creates accounts for each property they select to use the REAME APP, an exemplary embodiment of software platform associated with the disclosed system, for property management companies by signing into an admin panel. Further, a property manager associated with the property management company may submit an excel spreadsheet to the REAME APP super admin that may enter the building name, property ID code, and address. Once the super admin has set up the admin panel, the property management company may enter each properties team member's information which includes their name, company email address, and phone number. Each user whether on the staff or tenant side may create their REAME APP account. Further, the each user may enter a unique user name, password, phone number, and address with a unit number for their account. Then they are logged in and ready to use the app.

Further, the software platform may include a tenant app. Further, the software platform may include a maintenance app. Further, the maintenance app may ask the maintenance team member to create a user account. Further, the team member may view a home screen that may consist of all the work orders consistently updated with work orders with the newest at the top of the page. Further, a user interface associated with the tenant application may include a work order issue icon displayed on the tenant app home screen and may also display on the work order app home screen.

Additionally, in some embodiments, the work order app home screen may include a plurality of animated icons. For instance, a plurality of work order issue icons may be animated according to a corresponding a characteristic associated with a plurality work order issues. For example, a first work order issue icon corresponding to lighting appliances may include an animated light source icon and a second work order issue icon corresponding to an electric fan may include an animated fan icon. Further, an animated display of the work order issue icon may be triggered based on an interaction of the user with the work order issue icon. For example, when a user selects the first work order issue icon, the animated light source icon may flash a light source depicted therein. Likewise, when the user selects the second work order issue icon, the animated fan icon may be displayed to be in rotatory motion.

Further, the maintenance team member may click on a work order and see the tenant name, address, unit number, and work order issue. Further, the maintenance team member may see a description and/or picture if the tenant completed detailed work order. The maintenance team member may click confirm, drag a slider to indicate the time in 24 hours they will arrive. If the maintenance team member gets delayed, the maintenance team member may move the slider on from 0-30 minutes to indicate how long they will be delayed. Further, the maintenance team member may select that they have arrived. Once they have completed the work order, the maintenance team member may select that they have completed the work order or have the option to notify the tenant that a part needs to be ordered or a contractor requested to complete the work order. The work order then goes back to the maintenance team member's home screen.

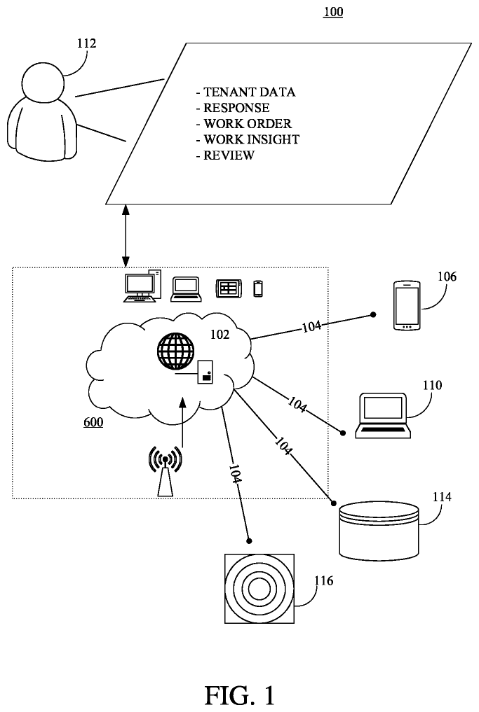

FIG. 1 is an illustration of an online platform 100 consistent with various embodiments of the present disclosure. By way of non-limiting example, the online platform 100 for facilitating maintaining a record of a work order may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, sensors 116, actuators (not shown) and an apparatus 118 over a communication network 104, such as, but not limited to, the Internet. Further, users of the online platform 100 may include relevant parties such as, but not limited to, end-users, maintenance companies, tenants, service providers, and administrators. Accordingly, in some instances, electronic devices operated by the one or more relevant parties may be in communication with the online platform 100.

A user 112, such as the one or more relevant parties, may access the online platform 100 through a web-based software application or browser. The web-based software application may be embodied as, for example, but not be limited to, a website, a web application, a desktop application, and a mobile application compatible with a computing device 600.

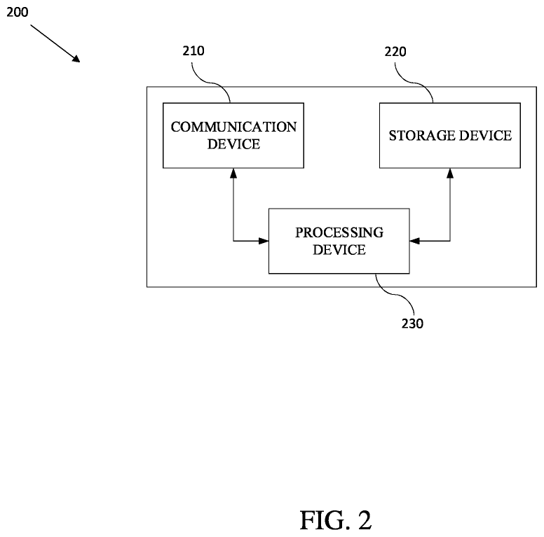

FIG. 2 is a block diagram of a system 200 for facilitating maintaining a record of a work order, in accordance with some embodiments. Accordingly, the system 200 may include a communication device 210 configured for receiving a tenant data from at least one tenant device associated with at least one tenant. Further, the tenant data may include name, address, email, contact number, etc. Further, the at least one tenant may include an individual, an institution, and an organization that may want to keep track (or record) status of a work order. Further, the at least one user device may include a smartphone, a tablet, a laptop, etc. Further, the communication device 210 may be configured for receiving a work order from the at least one tenant device. Further, the work order may be associated with a work (or task) that the at least one user may want a maintenance team to perform. Further, the work order may include work order information such as photo, video, textual query, etc. Further, the communication device 210 may be configured for transmitting the work order and the tenant data to at least one maintenance team device associated with the maintenance team. Further, the at least one maintenance team device may include a smartphone, a tablet, a laptop, a computer, etc. Further, the communication device 210 may be configured for receiving a response corresponding to the work order from the at least one maintenance team device. Further, the response may include an acceptance that may indicate that the at least one maintenance team may want to perform the work order. Further, the communication device 210 may be configured for transmitting the response to the at least one tenant device. Further, the communication device 210 may be configured for receiving a work status corresponding to the work order from the at least one maintenance team device. Further, the work status may include the amount of work done for indicating the progress of the work order. Further, the communication device 210 may be configured for transmitting a work insight to the at least one tenant device. Further, the communication device 210 may be configured for receiving a review corresponding to the work done by the at least one maintenance team from the at least one tenant device. Further, the review may include a star rating. Further, 5-star rating may indicate that the at least one tenant is extremely Satisfied and 1-star rating may indicate that the at least one tenant is not satisfied. Further, the communication device 210 may be configured for transmitting the review to the at least one maintenance team device.

Further, the system 200 may include a processing device 230 configured for analyzing the tenant data to generate a tenant account. Further, the tenant account may be associated with a username and a password. Further, the processing device 230 may be configured for processing the work order and the work status. Further, the processing device 230 may be configured for generating the work insight based on the processing. Further, the work insight may include illustration, in an instance, a test tube or thermometer, that may indicate the progress of the work done of the work order.

Further, the system 200 may include a storage device 220 configured for storing the review, the work insight, the tenant data, and the response.

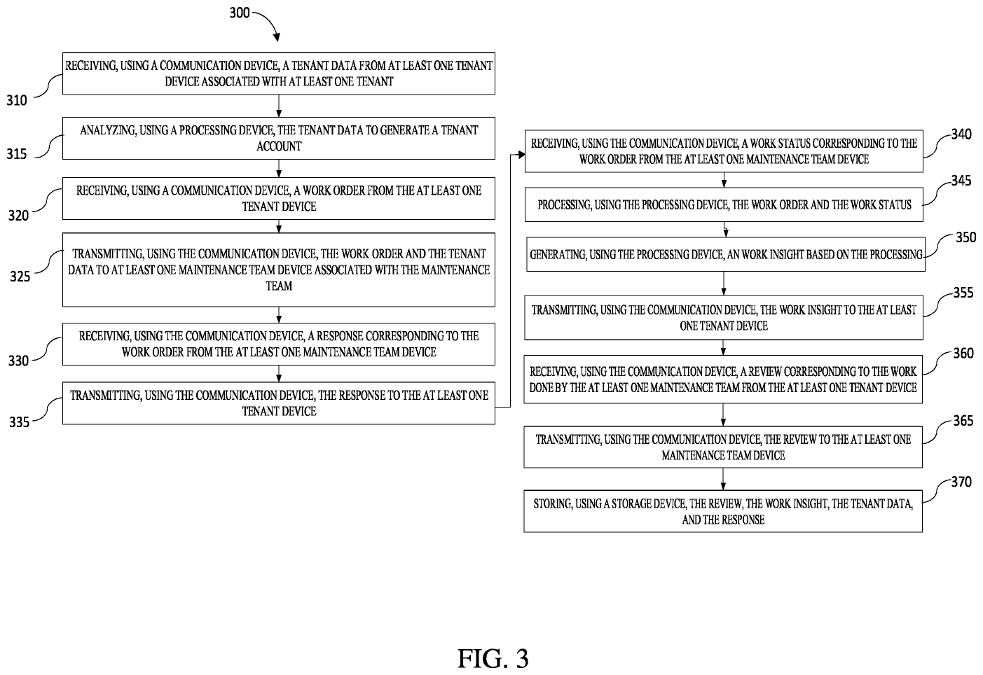

FIG. 3 is a flowchart of a method 300 for facilitating maintaining a record of a work order, in accordance with some embodiments. Accordingly, at 310, the method 300 may include receiving, using a communication device 210, a tenant data from at least one tenant device associated with at least one tenant. Further, the tenant data may include name, address, email, contact number, etc. Further, the at least one tenant may include an individual, an institution, and an organization that may want to keep track (or record) the status of a work order. Further, the at least one user device may include a smartphone, a tablet, a laptop, etc.

Further, at 315, the method 300 may include analyzing, using a processing device 230, the tenant data to generate a tenant account. Further, the tenant account may be associated with a username and a password.

Further, at 320, the method 300 may include receiving, using a communication device 210, a work order from the at least one tenant device. Further, the work order may be associated with a work (or task) that the at least one user may want a maintenance team to perform. Further, the work order may include work order information such as photo, video, textual query, etc.

Further, at 325, the method 300 may include transmitting, using the communication device 210, the work order and the tenant data to at least one maintenance team device associated with the maintenance team. Further, the at least one maintenance team device may include a smartphone, a tablet, a laptop, a computer, etc.

Further, at 330, the method 300 may include receiving, using the communication device 210, a response corresponding to the work order from the at least one maintenance team device. Further, the response may include an acceptance that may indicate that the at least one maintenance team may want to perform the work order.

Further, at 335, the method 300 may include transmitting, using the communication device 210, the response to the at least one tenant device.

Further, at 340, the method 300 may include receiving, using the communication device 210, a work status corresponding to the work order from the at least one maintenance team device. Further, the work status may include the amount of work done for indicating progress of the work order.

Further, at 345, the method 300 may include processing, using the processing device 230, the work order and the work status.

Further, at 350, the method 300 may include generating, using the processing device 230, a work insight based on the processing. Further, the work insight may include illustration, in an instance, a test tube or thermometer, that may indicate the progress of the work done of the work order.

Further, at 355, the method 300 may include transmitting, using the communication device 210, the work insight to the at least one tenant device.

Further, at 360, the method 300 may include receiving, using the communication device 210, a review corresponding to the work done by the at least one maintenance team from the at least one tenant device. Further, the review may include star rating. Further, 5-star rating may indicate that the at least one tenant is extremely Satisfied and 1-star rating may indicate that the at least one tenant is not satisfied.

Further, at 365, the method 300 may include transmitting, using the communication device 210, the review to the at least one maintenance team device.

Further, at 370, the method 300 may include storing, using a storage device, the review, the work insight, the tenant data, and the response.

In some embodiments, the method 300 may include additional steps related to maintenance team members, efficiency of the maintenance team members, admin devices used by administrators, and arrival times of the maintenance team members.

Maintenance team members.

In some embodiments, the method 300 may further include a step of receiving, using the communication device 210, maintenance team member data associated with the at least one maintenance team from the at least one maintenance team device. The maintenance team member data may include member information associated with each member of the at least one maintenance team.

The member team may include name, email address, phone number, etc. The method 300 may further include a step of analyzing, using the processing device, the maintenance team member data to generate member account corresponding to the each member. The member account may be associated with a username and a password. Finally, the method 300 may further include a step of storing, using the storage device 220, the member account.

Efficiency of the maintenance team members.

In some embodiments, the method 300 may include receiving, using the communication device 210, work data associated with the work done by the at least one maintenance team from at least one input device. The at least one input device may include a sensor configured for detecting the activity of the at least one maintenance team. The at least one input device may include a camera, a motion sensor, etc. disposed on site of the work order.

In an embodiment, the at least one input device may include a supervisor device such as a smartphone, a tablet, a laptop, etc. associated with a supervisor that may be present on site of the work order. Further, the method 300 may include generating, using the processing device 230, efficiency of the at least one maintenance team based on the work data. Further, the method 300 may include storing, using the storage device, the efficiency and the work data.

Admin devices used by administrators (Admin).

In some embodiments, the method 300 may further include steps of transmitting, using the communication device 210, the work insight, the response, the work order to at least one admin device associated with at least one admin. The at least one admin device may include a smartphone, a tablet, a laptop, a computer, etc. The at least one admin may include an individual, an institution, and an organization that may want to supervise the work order.

Arrival times of the maintenance team members.

In some embodiments, the method 300 may further include a step of receiving, using the communication device 210, an arrival time indication from the at least one maintenance team device, wherein the arrival time indication may include a time that may inform the at least one tenant about the arrival of the at least one maintenance team.

The arrival time indication may include a sliding drag button that may indicate the time in 24 hours format at which the at least one maintenance team may arrive. The arrival time indication may indicate that the at least one maintenance team may arrive on time or arrive at a delayed time. The method 300 may further include a step of transmitting, using the communication device 210, the arrival time indication to the at least one tenant device.

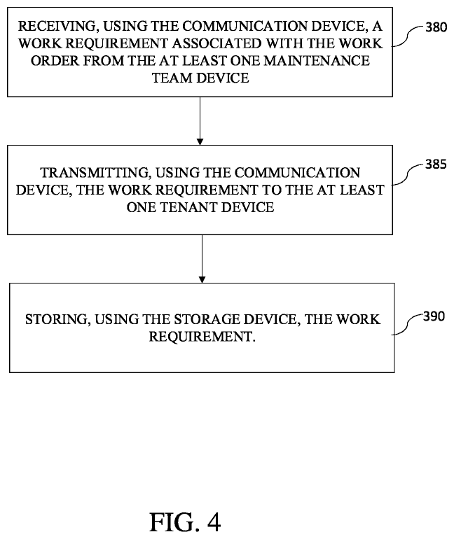

FIG. 4 is a flowchart of a method 300 for facilitating maintaining a record of a work order, in accordance with some embodiments. Accordingly, at 380, the method 300 may include receiving, using the communication device 210, a work requirement associated with the work order from the at least one maintenance team device. Further, the work requirement may notify the at least one tenant that a part needs to be ordered or a contractor needs to be requested to complete the work order. Further, at 385, the method 300 may include transmitting, using the communication device 210, the work requirement to the at least one tenant device. Further, the generating of the work insight may be based on the work requirement. Further, the work insight may include an indication corresponding to the work requirement. Further, at 390, the method 300 may include storing, using the storage device, the work requirement.

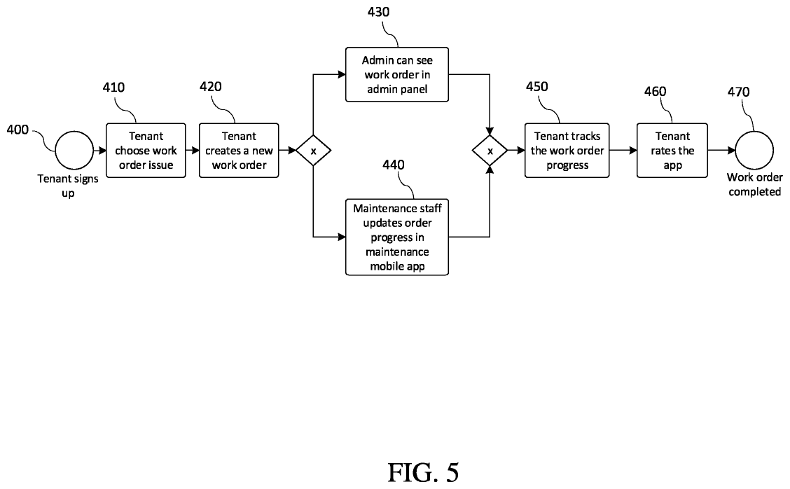

FIG. 5 is a flowchart of a method 300 for facilitating maintaining a record of a work order, in accordance with some embodiments. Accordingly, at 400, the method 300 may include singing up by a tenant. Further, at 410, the method 300 may include the tenant choosing a work order issue. Further, at 420, the method 300 may include the tenant creating a new work order. Further, at 430, the method 300 may include updating order progress by maintenance staff using a maintenance mobile application. Further, at 430, the admin may see a work order in an admin panel associated with the software platform disclosed system. Further, at 450, the method 300 may include the tenant tracking the work order progress. Further, at 460, the method 300 may include the tenant rating the software platform (or application) associated with the disclosed system. Further, at 470, the method 300 may include completing the work order.

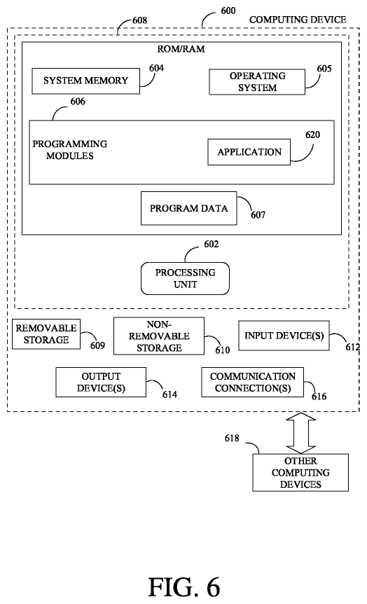

With reference to FIG. 6, a system consistent with an embodiment of the disclosure may include a computing device or cloud service, such as computing device 600. In a basic configuration, computing device 600 may include at least one processing unit 602 and a system memory 604. Depending on the configuration and type of computing device, system memory 604 may comprise, but is not limited to, volatile (e.g. random-access memory (RAM)), non-volatile (e.g. read-only memory (ROM)), flash memory, or any combination. System memory 604 may include operating system 605, one or more programming modules 606, and may include a program data 607. Operating system 605, for example, may be suitable for controlling computing device 600's operation. In one embodiment, programming modules 606 may include image-processing module, machine learning module and/or image classifying module. Furthermore, embodiments of the disclosure may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer-readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, a location sensor, a camera, a biometric sensor, etc. Output device(s) 614 such as a display, speakers, a printer, etc. may also be included. The aforementioned devices are examples and others may be used.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 604, including operating system 605. While executing on processing unit 602, programming modules 606 (e.g., application 620 such as a media player) may perform processes including, for example, one or more stages of methods, algorithms, systems, applications, servers, databases as described above. The aforementioned process is an example, and processing unit 602 may perform other processes. Other programming modules that may be used in accordance with embodiments of the present disclosure may include sound encoding/decoding applications, machine learning application, acoustic classifiers, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A method comprising:
receiving, using a communication device, a tenant data from at least one tenant device associated with at least one tenant;
analyzing, using a processing device, the tenant data to generate a tenant account;
receiving, using a communication device, a work order from the at least one tenant device;
transmitting, using the communication device, the work order and the tenant data to at least one maintenance team device associated with the maintenance team;
receiving, using the communication device, a response corresponding to the work order from the at least one maintenance team device;
transmitting, using the communication device, the response to the at least one tenant device;
receiving, using the communication device, a work status corresponding to the work order from the at least one maintenance team device;
processing, using the processing device, the work order and the work status;
generating, using the processing device, a work insight based on the processing;
transmitting, using the communication device, the work insight to the at least one tenant device;
receiving, using the communication device, a review corresponding to the work done by the at least one maintenance team from the at least one tenant device;
transmitting, using the communication device, the review to the at least one maintenance team device;
storing, using a storage device, the review, the work insight, the tenant data, and the response;
receiving, using the communication device, maintenance team member data associated with the at least one maintenance team from the at least one maintenance team device;
analyzing, using the processing device, the maintenance team member data to generate member account corresponding to the each member; and
storing, using the storage device, the member account.

2. The method as claimed in claim 1, further comprising:
receiving, using the communication device, work data associated with the work done by the at least one maintenance team from at least one input device that includes a motion sensor disposed on site of the work order;
generating, using the processing device, efficiency of the at least one maintenance team based on the work data;
storing, using the storage device, the efficiency and the work data;
transmitting, using the communication device, the work insight, the response, the work order to at least one admin device associated with at least one admin;
receiving, using the communication device, an arrival time indication from the at least one maintenance team device; and
transmitting, using the communication device, the arrival time indication to the at least one tenant device.

3. The method as claimed in claim 1, further comprising:
receiving, using the communication device, a work requirement associated with the work order from the at least one maintenance team device;
transmitting, using the communication device, the work requirement to the at least one tenant device; and
storing, using the storage device, the work requirement.

4. The method as claimed in claim 1, further comprising:
requesting, using the communication device, to sign up, choose a work order issue and create a new work order;
receiving, using the communication device, an updated order from a maintenance staff;
showing, using the communication device, the work order in an admin panel; and
showing, using the communication device, the work order for the tenant to track the work order progress.

5. The method as claimed in claim 1, wherein the work order includes work order information such as photo, video, and textual query.

6. The method as claimed in claim 1, wherein the response includes an acceptance indicating that the at least one maintenance team wants to perform the work order.

7. The method as claimed in claim 1, wherein the work status includes the amount of work done indicating progress of the work order.

8. The method as claimed in claim 1, wherein the work insight includes illustration, in an instance, a test tube or thermometer, that indicates the progress of the work done of the work order.

9. The method as claimed in claim 1, wherein the review includes star rating, where the star rating includes a 5-star rating that indicates that the at least one tenant is extremely Satisfied and a 1-star rating that indicates that the at least one tenant is not satisfied.

10. The method as claimed in claim 2, wherein the at least one input device includes a sensor configured for detecting the activity of the at least one maintenance team.

11. The method as claimed in claim 2, wherein the at least one input device includes a camera disposed on site of the work order.

12. The method as claimed in claim 2, wherein the at least one input device includes a supervisor device such as a smartphone, a tablet, a laptop associated with a supervisor present on site of the work order.

13. The method as claimed in claim 2, wherein the arrival time indication includes a time that informs the at least one tenant about the arrival of the at least one maintenance team.

14. The method as claimed in claim 2, wherein the arrival time indication includes a sliding drag button that indicates the time in 24 hours format at which the at least one maintenance team arrives.

15. A non-transitory computer readable medium containing computer-readable instructions stored therein for causing a computer processor to perform operations to:
receive, using a communication device, a tenant data from at least one tenant device associated with at least one tenant;
analyze, using a processing device, the tenant data to generate a tenant account;
receive, using a communication device, a work order from the at least one tenant device;
transmit, using the communication device, the work order and the tenant data to at least one maintenance team device associated with the maintenance team;
receive, using the communication device, a response corresponding to the work order from the at least one maintenance team device;
transmit, using the communication device, the response to the at least one tenant device;
receive, using the communication device, a work status corresponding to the work order from the at least one maintenance team device;
process, using the processing device, the work order and the work status;
generate, using the processing device, a work insight based on the processing;
transmit, using the communication device, the work insight to the at least one tenant device;
receive, using the communication device, a review corresponding to the work done by the at least one maintenance team from the at least one tenant device;
transmit, using the communication device, the review to the at least one maintenance team device; and
store, using a storage device, the review, the work insight, the tenant data, and the response.

16. The non-transitory computer readable medium as claimed in claim 15, wherein the work status includes the amount of work done for indicating progress of the work order.

17. The non-transitory computer readable medium as claimed in claim 15, wherein the work insight includes illustration, in an instance, a test tube or thermometer, that indicates the progress of the work done of the work order.

18. A non-transitory computer readable medium containing computer-readable instructions stored therein for causing a computer processor to perform operations to:
receive, using a communication device, a tenant data from at least one tenant device associated with at least one tenant;
analyze, using a processing device, the tenant data to generate a tenant account;
receive, using a communication device, a work order from the at least one tenant device;
transmit, using the communication device, the work order and the tenant data to at least one maintenance team device associated with the maintenance team;
receive, using the communication device, a response corresponding to the work order from the at least one maintenance team device;
transmit, using the communication device, the response to the at least one tenant device;
receive, using the communication device, a work status corresponding to the work order from the at least one maintenance team device;
process, using the processing device, the work order and the work status;
generate, using the processing device, a work insight based on the processing;
transmit, using the communication device, the work insight to the at least one tenant device;
receive, using the communication device, a review corresponding to the work done by the at least one maintenance team from the at least one tenant device;
transmit, using the communication device, the review to the at least one maintenance team device;
store, using a storage device, the review, the work insight, the tenant data, and the response;
receive, using the communication device, work data associated with the work done by the at least one maintenance team from at least one input device that includes a motion sensor disposed on site of the work order;
generate, using the processing device, efficiency of the at least one maintenance team based on the work data;
store, using the storage device, the efficiency and the work data;
receiving, using the communication device, an arrival time indication from the at least one maintenance team device; and
transmitting, using the communication device, the arrival time indication to the at least one tenant device.

19. The non-transitory computer readable medium as claimed in claim 18, wherein the at least one input device includes a camera disposed on site of the work order.

20. The non-transitory computer readable medium as claimed in claim 18, wherein the arrival time indication includes a sliding drag button that indicates the time in 24 hours format at which the at least one maintenance team arrives.
